(19) United States
(12) Patent Application Publication
(10) Pub. No.: US 2009/0113408 A1
(43) Pub. Date: Apr. 30, 2009

(54) SYSTEM SYNCHRONIZATION IN CLUSTER

(75) Inventor: Maria Toeroe, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/968,323

(22) Filed: Jan. 2, 2008

Related U.S. Application Data
(60) Provisional application No. 60/983,774, filed on Oct. 30, 2007.

(51) Int. Cl. G06F 9/44

(52) U.S. Cl. 717/168

(57) ABSTRACT

A machine, cluster, computer program product and method for choosing an attribute, based on an occurrence of a predetermined event, to be used in a machine of a cluster that includes plural machines. The method includes storing a runtime variable and a configuration variable for each machine of the cluster, selecting, upon the occurrence of the predetermined event, an attribute from a first list of at least one attribute included in the runtime variable in the cluster, accessing, if the runtime variable is not available, the configuration variable, where the configuration variable includes a second list of at least one attribute and selecting an attribute from the second list, and using the selected attribute in the machine.

### RELATED APPLICATION

This application is related to, and claims priority from, U.S. Provisional Patent Application Ser. No. 60/983,774, filed on Oct. 30, 2007, entitled “Operating system synchronization in cluster” to Maria Toeroe, the entire disclosure of which is incorporated here by reference.

### TECHNICAL FIELD

This application relates to synchronizing state attributes in a computer cluster and, more particularly, to the synchronization of operating system selection from multiple operating systems in a computer cluster.

### BACKGROUND

The IT infrastructure of a company is conventionally centered around computer servers that are linked together via various types of networks, such as private local area networks (LANs) and private and public wide area networks (WANs). The servers are used to deploy various applications and to manage data storage and transactional processes. These servers include stand-alone servers and/or higher density servers.

Recently, intensive computational tasks have motivated users to connect the servers in clusters to achieve faster results. A cluster is a group of computers/servers that work together closely so that, in many respects, the computers/servers can be viewed as though they are a single computer/server. The components of a cluster are commonly, but not always, connected to each other through fast local area networks. Clusters are usually deployed to improve performance and/or availability over that provided by a single computer, while typically being much more cost-effective than single computers of comparable speed or availability.

In the cluster, each node (or machine or computer) boots an operating system or a hypervisor with multiple operating systems. As known by one of ordinary skill in the art, a hypervisor is a platform that allows multiple operating system instances to run simultaneously on a host machine at the same time. The booting process should be synchronized across the cluster so that the appropriate operating system is booted on each of the machines. In other words, each node should boot the intended operating system on any occasion, i.e., after an upgrade or a catastrophic failure or any other event that forces the node to reboot.

Preferably, the machines in a cluster should not switch in an uncontrolled manner from one operating system to another even if there is more than one operating system available. For example, in catastrophic cases, it might be desirable to switch all machines back to a backup version of an operating system. However, when this fallback is to be performed, the system may be in a condition that it cannot be trusted to carry out any configuration change.

The dependability of the global communication infrastructure is important. Communications and computer equipment among other things should incorporate the highest possible levels of availability and dependability while balancing the constraints of short development cycles and increasing pressure to reduce development costs. The Service Availability Forum (SA Forum), a cooperative effort of industry members, was formed to improve this situation by developing standard interfaces to enable the delivery of highly available carrier-grade systems with off-the-shelf hardware platforms, middleware and service applications. By standardizing the interfaces for systems to implement high levels of service availability, the SA Forum aims to help drive progress in service availability. More information and specifications developed by the SA Forum are available at www.saforum.org.

The SA Forum is unifying functionality to deliver a consistent set of interfaces, thus enabling consistency for application developers and network architects alike. This means significantly greater reuse and a quicker turn around for new product introduction. The high-availability software which is developed in accordance with SA Forum specifications is characterized by specifications that are hardware independent and operating systems independent. For example, in the SA Forum specifications, the afore-described control over booting operating systems is proposed to be performed by a platform management service (PLM), which is characterized by a model. In the model, an operating system instance is referred to as an execution environment (EE). The hardware (HW) is represented as a physical resource (PR).

In a conventional machine, there is a boot order of operating system images {e.g., OS1, OS2, OS3} that could come from different sources (e.g., hard drive, network, flash memory), but typically the operating system images serve the same purpose. The hardware knows this order and tries to boot OS1 first. If this boot fails, then the system tries to boot OS2. If this fails, then the system tries to boot OS3. In other cases, OS1 and OS2 are different versions of an operating system and OS3 is a diagnostic system that is desired to be used when the first two operating systems fail and there is a need to diagnose the failure of the system to fix it. On these occasions, it is desirable to boot OS3 on purpose and not the other operating systems. However, in a cluster it may not be desirable to automatically switch to OS3 even in case of failure of the entire system. Instead, the switch to OS3 should happen only when requested by the user. Thus, in the PLM model these conditions could be represented as two execution environments: EE1 {OS1, OS2} and EE2 {OS3}.

When a backup process is desired, the cluster boot up sequence can be setup in a manner similar to the above discussed example, i.e., OS1 as the desired operating system, OS2 as the backup system, and OS3 as the diagnostic system. As discussed above, in the cluster, it may not be desired to have automatic switches to any of the operating systems unless there is a controlled way to do so. In this example, the three operating systems can be represented as three execution environments: EE1 {OS1}, EE2 {OS2}, EE3 {OS3}. The PLM needs to ensure that when EE1 needs to be booted it is always OS1 which comes up and not OS2 or OS3. This means that PLM assistance is needed in any boot if the HW would switch between these sources automatically.

In a cluster environment, there is an added value in controlling which operating system is running on each machine (e.g., to make sure all services are at a same revision, etc.). Each machine may have multiple operating systems available (e.g., as backup or diagnostic versions). It is thus important that a backup operating system is not brought up if it does not correspond to the current system. Another common problem associated with conventional clusters is how to configure the PLM in such a way that the PLM boots the desired execution environment, (i) which during an upgrade, for example, is different than the backup execution environment, and (ii) when a cluster-wide reboot is performed, the backup execution environment needs to be automatically brought up on all machines.

### SUMMARY

According to an exemplary embodiment, a method for choosing an attribute, based on an occurrence of a predetermined event, to be used in a machine of a cluster that includes plural machines, includes storing a runtime variable and a configuration variable for each machine of the cluster, selecting, upon the occurrence of the predetermined event, an attribute from a first list of at least one attribute included in the runtime variable in the cluster, accessing, if the runtime variable is not available, the configuration variable, where the configuration variable includes a second list of at least one attribute and selecting an attribute from the second list, and using the selected attribute in the machine.

According to another exemplary embodiment, a cluster includes plural machines, each configured to read at least one runtime variable that includes a first list of at least one attribute, and at least one configuration variable that includes a second list of at least one attribute; communication ports configured to connect the plural machines to form the cluster and configured to transit information including the at least one runtime variable and the at least one configuration variable; and a memory configured to store the at least one runtime variable, the at least one configuration variable, and a platform management service, the platform management service being configured to maintain the at least one configuration variable and to initialize the at least one runtime variable when all the machines of the cluster are shutdown.

Still according to another exemplary embodiment, a machine is part of a cluster that includes common control software configured to control the machine and the cluster includes other machines. The machine includes a processor configured to read, upon an occurrence of a predetermined event, at least one runtime variable that includes a first list of at least one attribute, and at least one configuration variable that includes a second list of at least one attribute; and a memory configured to store the least one runtime variable, the at least one configuration variable, and a platform management service, the platform management service being configured to maintain the at least one configuration variable and to initialize the at least one runtime variable when all the machines of the cluster are shutdown.

According to still another exemplary embodiment, a computer readable medium includes computer executable instructions, wherein the instructions, when executed by a processor that is part of a machine in a cluster, cause the processor to perform a method including storing a runtime variable and a configuration variable for each machine of the cluster; selecting, upon an occurrence of a predetermined event, an attribute from a first list of at least one attribute included in the runtime variable in the cluster; accessing, if the runtime variable is not available, the configuration variable, where the configuration variable includes a second list of at least one attribute of the machine and selecting an attribute from the second list; and using the selected attribute in the machine.

According to another exemplary embodiment, a machine that is part of a cluster that includes common control software configured to control the machine and other machines of the cluster, includes a unit for storing a runtime variable and a configuration variable for each machine of the cluster; a unit for selecting, upon an occurrence of a predetermined event, an attribute from a first list of at least one attribute included in the runtime variable if the runtime variable is available in the cluster; a unit for accessing, if the runtime variable is not available, the configuration variable, where the configuration variable includes a second list of at least one attribute and selecting an attribute from the second list; and a unit for using the selected attribute in the machine.

### BRIEF DESCRIPTION OF THE DRAWINGS

A more complete understanding of the exemplary embodiments may be gained by reference to the following ‘Detailed description’ when taken in conjunction with the accompanying drawings. The accompanying drawings, which are incorporated in and constitute a part of the specification, illustrate one or more embodiments and, together with the description, explain these embodiments. In the drawings:

FIG. 1 is a schematic diagram showing a cluster that includes physical resources according to an exemplary embodiment;

FIG. 2 is a schematic diagram showing the structure of one physical resource shown in FIG. 1;

FIG. 3 is an exemplary architectural view of a cluster in accordance with one embodiment;

FIG. 4 is an exemplary architectural view of a node in accordance with one embodiment;

FIG. 5 is an exemplary table showing a list of attributes that includes at least one operating system included in a runtime variable;

FIG. 6 is an exemplary table showing a list of attributes that includes at least one backup operating system included in a configuration variable;

FIG. 7 is an exemplary flow chart illustrating how nodes in a cluster reboot according to an embodiment; and

FIG. 8 is an exemplary flow chart illustrating steps for performing a method of choosing an attribute in a machine in a node of the cluster.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

As described above, in a cluster environment there is an advantage in controlling which operating system is running on each node (e.g., to ensure that all services are provided by the same version of an operating system). Each node may have multiple operating systems available (e.g., as backup or diagnostic versions). However, it is desirable that a backup operating system is not brought up if the backup operating system does not correspond to the current system. Other situations will likewise benefit from mechanisms according to these exemplary embodiments which control the operating system to be booted on each node in a cluster or, more generally, the state of each node in a cluster. For example, instead of controlling the operating system to be booted on each machine, according to one exemplary embodiment, an attribute of the machine is controlled. The attribute may be related to a version of a software component, an IP address, a port number, a particular configuration file, an application code location, and a network file system mounting point. One skilled in the art would appreciate other attributes. However, for simplicity, in the following exemplary embodiments the attribute is assumed to be related to an operating system, a backup system, or a diagnostic system.

The cluster will choose the attribute based on an occurrence of a predetermined event. The predetermined event may be in one embodiment the shutdown of the cluster. The shutdown of the cluster occurs, for example, when each of the machines of the cluster loses connectivity to the cluster or does not responds to input commands. Another situation that results in the shutdown of the cluster is when a user inputs a command to the cluster to reset all the machines of the cluster or when the user simply switches off the power of the cluster. As will be discussed in the following exemplary embodiments, an appropriate attribute will be selected to be used in the machine or/and in the cluster. The selected attribute may be used to perform at least one of: rebooting the machine, updating a software component of the machine, and transferring data from the cluster to the machine. Prior to discussing, for example, how the appropriate operating system is selected, a brief description of a cluster system is provided below for context.

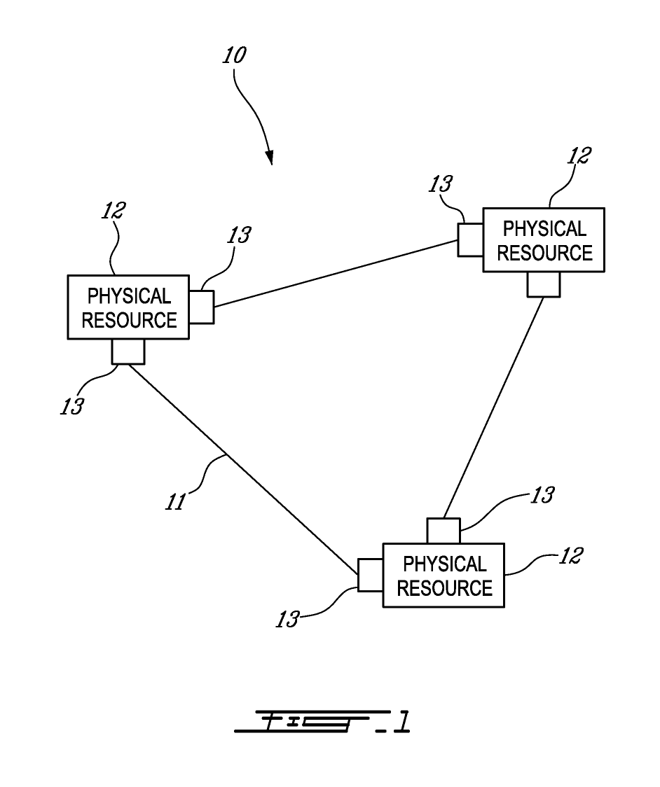

FIG. 1 shows a cluster system 10 having three physical resources 12 connected to each other via communication lines 11. The connections between the physical resources 12 shown in FIG. 1 are exemplary and not intended to limit the exemplary embodiments. A communication port 13 may be located between the physical resource 12 and a corresponding communication line 11. The communication lines 11 may be physical lines or wireless channels. The cluster system 10 may include any number of physical resources. Each physical resource may be a computer, a server, or a unit that includes a processor connected to a memory device. The term “machine” will be used herein as a generic term for all of these possibilities. The cluster 10 is also characterized by control software which is shared by all the physical resources and which manages predetermined aspects of the physical resources, for example, an upgrade of software or an operating system of each physical resource. The control software may be located on a predetermined number of nodes of the cluster.

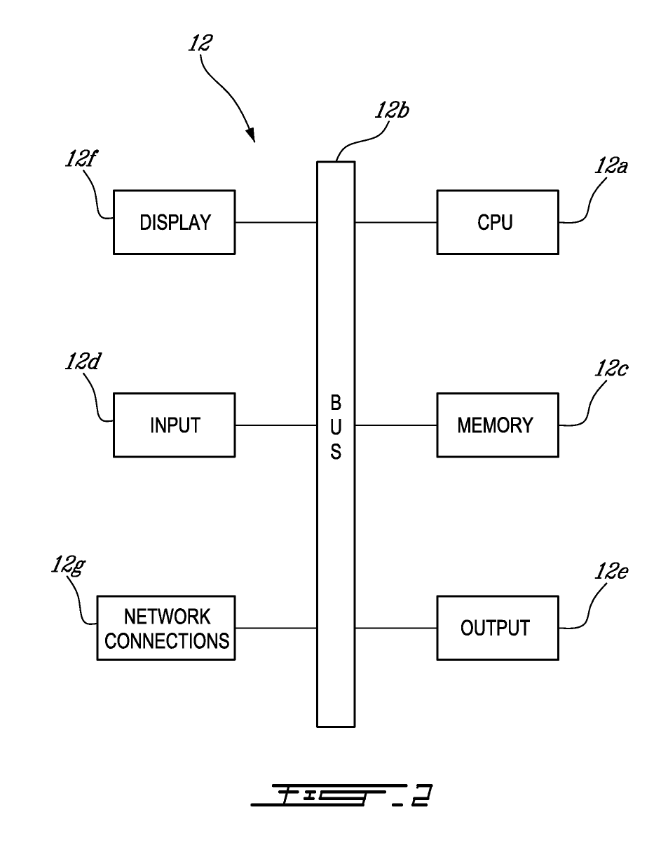

In one embodiment, the physical resource 12 includes a CPU processor 12a connected to a bus 12b as shown in FIG. 2. The processor 12a is coupled via the bus 12b to a memory 12c for storing data. The components of the memory 12c may be selected to fit a desired application, including not only chip and flash-based memories, but also hard drives, optical drives or other types of memories. An input 12d is also connected to the bus 12b and is configured to receive data from a media database, a modem, a user input device, a satellite, etc. The physical resource 12 also includes an output 12e connected to the bus 12b. As with the input 12d, the output 12e may include multiple output types to suit various display devices or communication devices. Further, the physical resource 12 may include a display unit 12f that is configured to display as an image an output from the memory 12c or the CPU 12a. The display unit 12f may, for example, be a CRT display, an LCD, or other known units for displaying an image or text. The display unit 12f may be connected directly to the output 12e instead of the bus 12b. The physical resource 12 may include a network connection unit 12g to connect the physical resource 12 to one or more other physical resources or external networks. The network connection unit 12g may be an Ethernet connection, wireless connection, WiFi connection, or any other network connection.

According to one embodiment, to enable machines of the cluster 10 to automatically reboot with the desired operating system, e.g., in case these machines have to reboot for various reasons, the desired execution environment for each machine is indicated in a volatile, cluster-wide, runtime variable that has the desired value of the execution environment. As long as the whole cluster 10 does not reboot at the same time, the runtime variable holds its value as there is at least one machine (that does not reboot) available to keep the runtime information. This runtime information overrides the default of each machine, and the PLM (or other control software entity) uses the runtime variables to select the desired execution environment to boot the machines as necessary. In one embodiment, each machine of the cluster has a corresponding runtime variable and, thus, the PLM administers and updates these values as will be discussed next. In another embodiment, selected groups of machines use a common runtime variable, for example, when each machine in the group uses the same execution environment. If the shutdown of all the machines of the cluster occurs, the runtime variable becomes unavailable.

In the following, as discussed above, for simplicity of the discussion, the exemplary embodiments refer to controlling booting of the operating system. However, the devices, processes, methods and computer programs discussed herein also apply more generally to controlling state attributes of nodes or machines, for example returning a node to its state at a particular time. Generically, a state attribute is any quantity describing a characteristic of the system or machine that might change from (i) a first state, prior to rebooting the machine, to (ii) a second state, after the machine was rebooted.

In the scenario where all the machines of the cluster reboot at the same time, the runtime information in the runtime variables is lost as no machine remains to keep the values of the runtime variables. In fact, the runtime variables can be defined in such way that upon reboot of all the machines of the cluster, the values of all runtime variables are erased. In one embodiment, the values of the runtime variables are automatically set to a default value, e.g., null or zero, only when the whole cluster reboots. In one embodiment, the PLM sets the runtime variable. In another embodiment, the runtime variable is configured to initialize with a value of the configuration variable when the whole cluster reboots. Thus, under these circumstances, a persistent, cluster-wide, configuration variable is used for each machine of the cluster to load the desired execution environment value, which is by default, the backup execution environment. The PLM uses, for each node, the appropriate default stored in the corresponding configuration variable. In other words, similar to the runtime variable, each machine may have its own configuration variable or a group of machines may share a same configuration variable. The configuration variables should not be affected by a shutdown of all the machines of the cluster and for this reason the configuration variables are maintained in a non-volatile memory, e.g., a hard disc. Thus, according to this exemplary embodiment, the whole cluster falls back, without any external intervention, to a trusted state that existed prior to rebooting the whole system. It will be explained next in more detail how the desired execution environment value is achieved in the case when the whole cluster reboots, and also in the case when only part of the nodes of the cluster reboot.

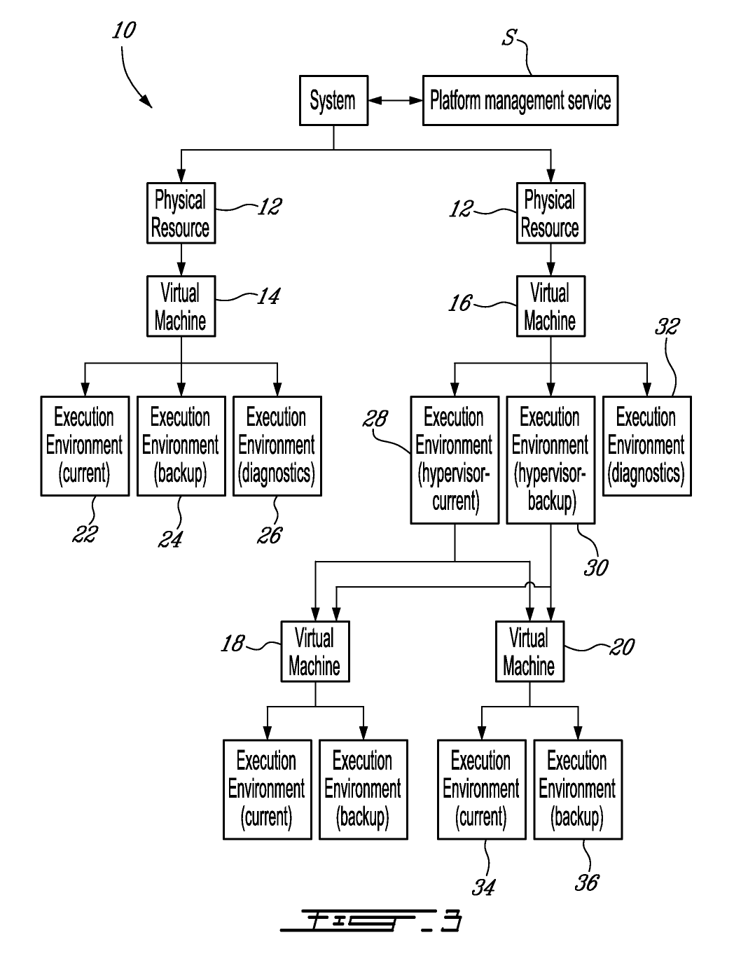

FIG. 3 presents a more specific view of the system 10 shown in FIG. 1. At a high level, FIG. 3 shows the system 10 and the PLM service S interacting with each other. More specifically, in one exemplary embodiment, system 10 may be composed of multiple physical resources 12, each capable of running a virtual machine (VM) 14. The notion of virtual machine is introduced to make it easier to understand the place where an execution environment is loaded. The virtual machine running on a physical resource can be a single virtual machine 14 or a hypervisor virtual machine 16 that runs multiple leaf virtual machines 18 and 20, provided that one of the appropriate execution environments 28 or 30 is loaded. The number of virtual machines shown in FIG. 3 is not restrictive but is used as a non-limiting example for illustrating a specific configuration of the system 10. One skilled in the art will recognize that various other configurations with different numbers of physical resources and virtual machines are possible.

FIG. 3 shows various execution environments 22, 24, 26, 28, 30 and 32. Two execution environments 28 and 30 could run, for example, the same leaf virtual machines, but this is not necessarily the case. Each execution environment may have its own set of leaf virtual machines defined. On a particular physical resource 12, the virtual machines could be configured in layers, with virtual machine 16 in a layer hierarchically superior to a layer formed by virtual machines 18 and 20.

However, each virtual machine 16, 18 and 20 may have its own distinct set of execution environments. For example, FIG. 3 shows virtual machine 16 having a set of execution environments including execution environments 28, 30 and 32 and virtual machine 20 having a different set of execution environments that includes execution environments 34 and 36. The sets of the execution environments may be identical for different virtual machines in one embodiment.

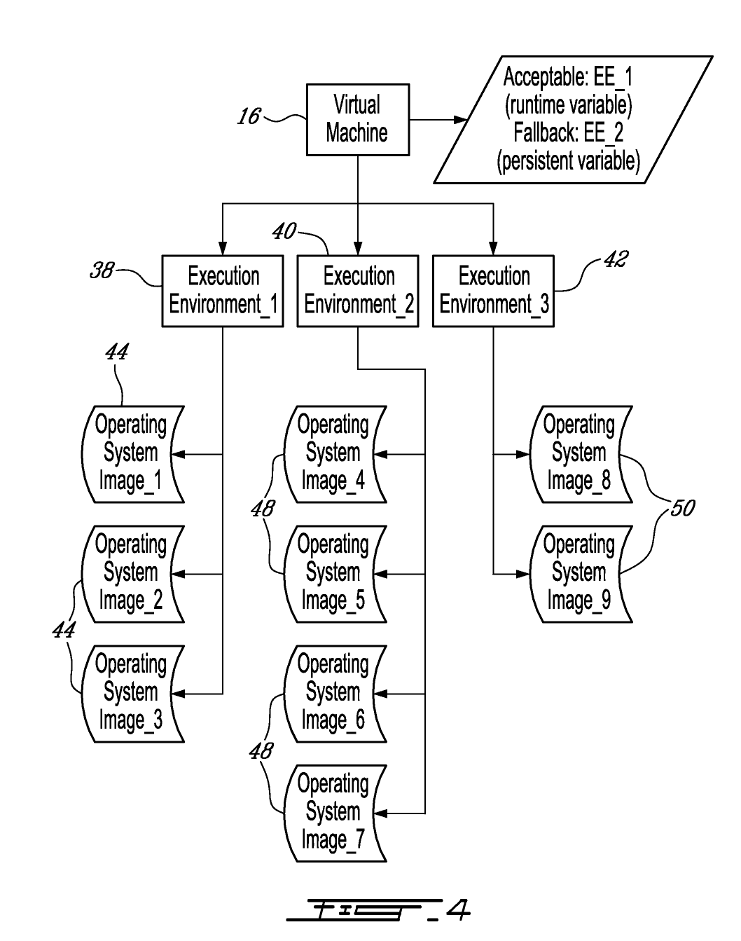

FIG. 4 shows in more detail that each virtual machine 16 can have multiple execution environments 38, 40, and 42, each of which can have multiple operating system images 44, 48, and 50, respectively. An operating system image is a stored binary code, which is loaded into the machine to execute the operating system as an execution environment. The operating system images belonging to the same execution environment are equivalent from a functional perspective. Also, the operating system images that correspond to different execution environments may be identical. FIG. 4 shows different operating system images for different execution environments for illustrative purposes.

As discussed above, in a cluster environment, it may be desirable that a backup operating system is not brought up if the backup operating system does not correspond to the current system configuration. In other words, if a machine was successfully updated from operating system A to operating system B, e.g., during a reboot process, it may be desirable to use the new operating system B and not the backup operating system A. However, there are instances when the backup operating system A or other operating systems should be used instead. These exemplary embodiments present a mechanism that allows an appropriate operating system to be used, depending on the status of the system, as will be discussed next.

To achieve the features discussed above, in one embodiment, each virtual machine is configured to select one of two associated variables: (1) the runtime variable, which defines an acceptable execution environment, and (2) the configuration variable, i.e., a variable that is available even when all the nodes in the cluster reboot at the same time. These variables are stored for each node in predetermined nodes. The runtime variable (the first variable) maintains the current acceptable execution environment of the virtual machine. The runtime variable is a cluster-wide, volatile, variable that is maintained as long as at least one cluster member is capable of maintaining this information. Each machine that boots (or reboots) can receive its corresponding runtime variable to obtain the acceptable execution environment. However, the runtime variable becomes unavailable when all the machines of the cluster reboot at the same time. In other words, the runtime variable is a volatile variable with respect to the cluster.

In one exemplary embodiment, a machine, which is part of a cluster that includes common control software configured to control the machine and where the cluster includes other machines, includes a processor and a memory as shown for example in FIG. 2. The processor may be configured to read, upon an occurrence of a predetermined event (e.g., reboot), the runtime variable that includes a first list of at least one attribute, and the configuration variable that includes a second list of at least one attribute. The memory is configured to store the runtime variable, the configuration variable, and a platform management service (e.g., PLM). The platform management service is configured to maintain the configuration variable and to initialize the runtime variable when all the machines of the cluster are shutdown. The machine may, upon the occurrence of the predetermined event, select the at least one attribute from the first list if the runtime variable is available, access, if the runtime variable is not available, the configuration variable and select the at least one attribute from the second list, and use the selected attribute in the machine. The machine may use the selected attribute to perform at least one of: rebooting the machine, updating a software component of the machine, and transferring data from the cluster to the machine. The predetermined event is a reboot of all the machines of the cluster.

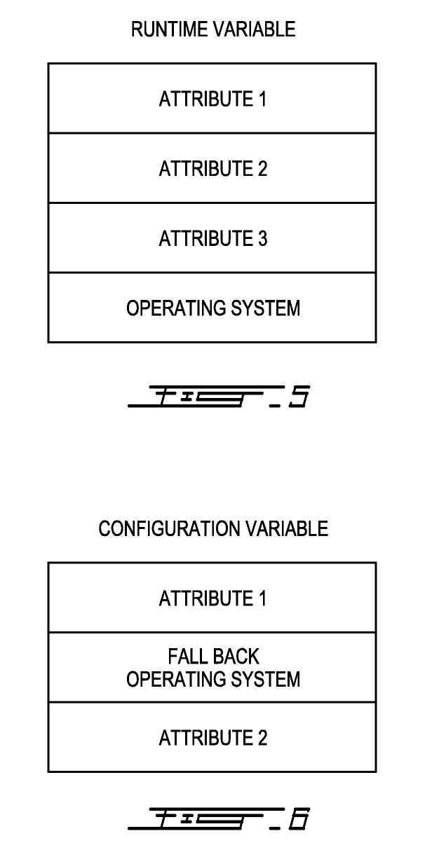

The runtime variable may include a list of attributes that includes at least one acceptable operating system. FIG. 5 shows an exemplary list 52 included in the runtime variable with four different attributes, one of the attributes being an operating system. Additional or alternative values of the attributes are discussed later. Other configurations are also possible as will be appreciated by one skilled in the art. A runtime variable may be defined and accessible to each cluster member. As discussed above, the runtime variable can be used not only to ensure that an appropriate operating system is used for the corresponding machine but also to ensure that state attributes of the machine are reused or renewed when the machine reboots.

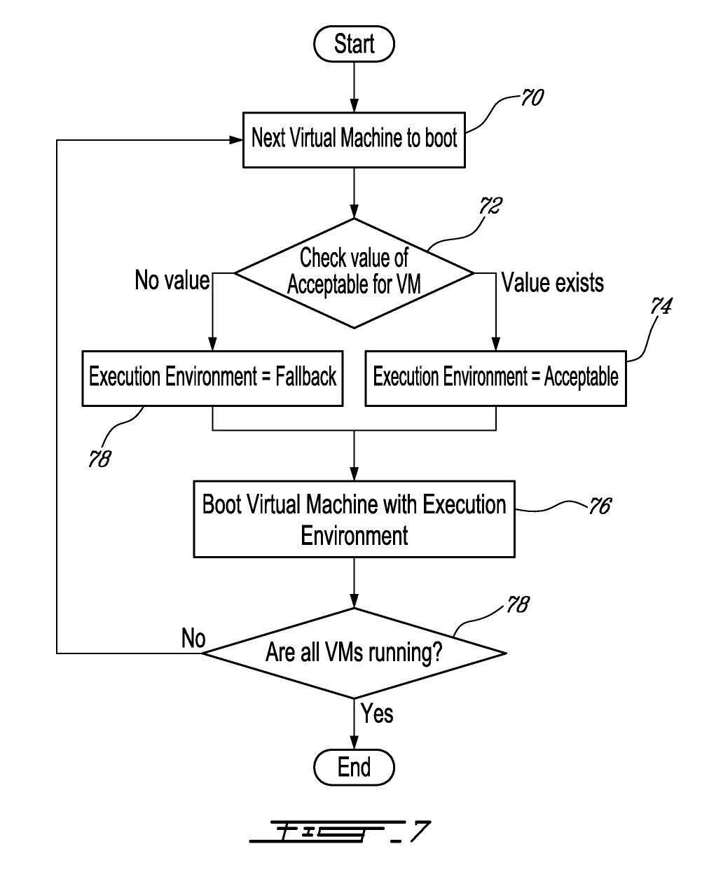

The configuration (or default) variable (the second variable) is used according to these exemplary embodiments to define the fallback execution environment of the machine. The configuration variable is maintained in a persistent memory (not erased by the shutdown of all the nodes of the cluster at the same time) and is used as a default value for the runtime variable. A configuration variable is defined for each cluster machine to maintain the fallback execution environment of that machine. Alternatively, a configuration variable is used for a group of machines, which form a subset of the machines of the cluster. In one embodiment, the configuration variable is maintained in the machine itself. Alternatively, the configuration variable is made available from a networked location, for example, another machine. In one embodiment, the configuration variable includes a list 60 of attributes as shown in FIG. 6. The list includes, at a minimum, an identifier of (or pointer toward) a single fallback operating system.

Exemplary uses of the runtime variable and the configuration variable are discussed next. As long as the whole cluster does not reboot at the same time, the runtime variable determines for each corresponding machine which operating system is used. For example, if it is desired to restart a machine A using a diagnostic system, the runtime variable would include, e.g., in a position that corresponds to the operating system to be used, the diagnostic system. Thus, after machine A is shut down, it will restart using the runtime variable, which instructs machine A to use the diagnostic system. Alternatively, when machine A is upgraded to a new operating system, the PLM would update the runtime variable to direct machine A to restart with the new operating system, and machine A will restart with this new operating system any time it is rebooted subsequently, provided not all the nodes of the cluster are restarted simultaneously. This process is repeated for each machine when the operating system or other software or state attributes of the machines are changed or upgraded as long as all the machines in the cluster are not rebooted at the same time.

The configuration variable is used when the runtime variable is undefined, for example when all the machines of the cluster are restarted at the same time. Suppose that machines A to F in a particular cluster have been upgraded to new operating systems and this is reflected by the setting of their runtime variables to this new operating system, while the configuration variable contains the value for the old operating system. In machines G to M in that cluster are still using the old operating systems, thus the value of their runtime variable is equal to the value of the configuration variable. An event occurs in that cluster which results in a failure of the cluster, such that all of the machines A to M have to reboot. The cluster has, at this instant, a group of machines with new operating systems and another group of machines with the old operating systems. Because the cluster has to be up and running to provide the required services, and because the cluster cannot be trusted due to the catastrophic failure, it is desirable that each machine of the cluster will restart using the operating system identified in the corresponding configuration variable and not that identified in the runtime variable. Thus, for example, the cluster could restart with each of the machines booting the old operating system, i.e., the state of the cluster prior to upgrading machines A to F to the new operating systems. Thus, in case of rebooting the whole cluster at a same time, values of the runtime variables are lost and only values of the configuration variables are used to restart the cluster. In one embodiment, the runtime variable is initialized after the whole cluster has been restarted based on the value of the configuration variable.

The runtime and configuration variables in the SA Forum cluster are maintained, in one embodiment, by the Information Model Management Service (IMM) as part of the information model of PLM. IMM defines runtime and configuration objects and attributes. Some runtime attributes can also be classified as persistent. Thus, for the IMM, the acceptable execution environment can be represented by a runtime attribute (no persistency) and the fallback execution environment can be represented by a configuration attribute (or by a persistent runtime attribute).

The foregoing exemplary embodiments regarding operating system management also apply to other state attributes of the machines, such as a version of existing software, an IP address, a port number, a particular configuration file, an application code location, a network file system mounting point that needs to be set in one way for the old structure of the cluster and in a different way for the upgraded cluster, etc., as will be appreciated by those skilled in the art. These attributes may be used in one embodiment even if the operating system remains unchanged when a machine or the cluster reboots. Further, such attributes may be managed in a manner similar to that described above when a software component is upgraded or when any data is pushed on the machine such that a state of the machine changes.

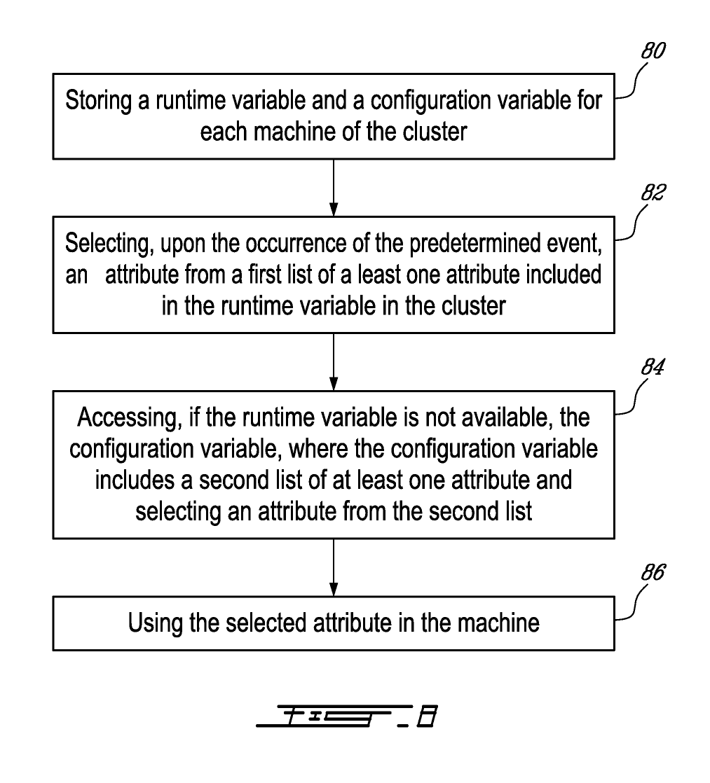

A machine of the cluster, in order to use the above discussed methods, is configured to select and use (i) the runtime variable when the machine reboots but at least another machine of the cluster does not reboot, and (ii) the configuration variable when not only the instant machine reboots but all other machines of the cluster reboot at the same time. FIG. 7 illustrates exemplary steps performed by the cluster's Boot Manager or, in embodiments using architecture in accordance with systems specified by the SA Forum environment, by PLM, to select the appropriate execution environment for each virtual machine that needs to be booted. The term “manager” is used in the following as the generic term for the Boot Manager, PLM or other control software entities which perform similar functions. The manager controls all the boots in the cluster system according to one embodiment. If there is a virtual machine to boot as shown in step 70, the manager checks in step 72 whether a value of the runtime variable indicating the acceptable execution environment for that machine exists. If the value exists, the manager then selects (in step 74) the execution environment to boot the virtual machine in step 76. If no value of the execution environment exists (e.g., the whole cluster rebooted and the value of the runtime variable was lost and it was not yet set), then the manager defaults in step 78 to the fallback execution environment and boots the virtual machines with their corresponding values from the configuration variables in step 76. In step 79, if all the virtual machines are running, the process ends. Otherwise, the process starts again with step 70 for booting the next virtual machine.

FIG. 8 illustrates the steps of a method for choosing an attribute, based on an occurrence of a predetermined event, to be used in a machine of a cluster that includes plural machines. The method includes storing in step 80 a runtime variable and a configuration variable for each machine of the cluster, selecting in step 82, upon the occurrence of the predetermined event, an attribute from a first list of at least one attribute included in the runtime variable in the cluster, accessing in step 84, if the runtime variable is not available, the configuration variable, where the configuration variable includes a second list of at least one attribute and selecting an attribute from the second list, and using in step 86 the selected attribute in the machine.

It will be appreciated that the storage of the runtime variable and the configuration variable need not occur at the same time as the other steps and may be performed in conjunction with cluster operations other than the method steps illustrated in FIG. 8.

These exemplary embodiments provide a machine, a cluster, a method and a computer program product for choosing an appropriate operating system for a machine in a node of a cluster. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a machine, cluster, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

The methods and processes described above synchronize the loading of operating systems, other software or data within a cluster. Particularly, the methods and processes described above synchronize, cluster-wide, the selection of the fallback attributes in a way that requires no external intervention or configuration of the cluster system that may be in a faulty condition and thus, cannot be trusted.

What is claimed is:

1. A method for choosing an attribute, based on an occurrence of a predetermined event, to be used in a machine of a cluster that includes plural machines, the method comprising:
storing a runtime variable and a configuration variable for each machine of the cluster;
selecting, upon the occurrence of the predetermined event, an attribute from a first list of at least one attribute included in the runtime variable in the cluster;
accessing, if the runtime variable is not available, the configuration variable, wherein the configuration variable includes a second list of at least one attribute and selecting an attribute from the second list; and
using the selected attribute in the machine.

2. The method of claim 1, wherein the runtime variable is unavailable after a shutdown of all machines in the cluster.

3. The method of claim 2, wherein the shutdown of all machines of the cluster occurs when:
each of the machines of the cluster loses connectivity to the cluster or does not respond to input commands, or
a user either sends a command to the cluster to reset all the machines or switches off the power of the cluster.

4. The method of claim 1, wherein the predetermined event is a reboot of all the machines of the cluster.

5. The method of claim 1, further comprising:
using the selected attribute to perform at least one of: rebooting the machine, updating a software component of the machine, and transferring data from the cluster to the machine.

6. The method of claim 1, further comprising:
providing, for each machine, the runtime variable and the configuration variable by a platform management service located in at least one predetermined machine of the cluster, wherein the platform management service is available when operating systems of part of the machines or hardware of the part of the machines fail.

7. The method of claim 2, wherein the configuration variable is a persistent variable that is available after the shutdown of each of the machines of the cluster.

8. The method of claim 1, further comprising:
initializing the runtime variable to a value of the configuration variable when the runtime variable is not available.

9. The method of claim 1, wherein the attribute of the first list is different from the attribute of the second list.

10. The method of claim 1, wherein the attribute of the runtime variable and the attribute of the configuration variable are related to one of an operating system, a backup system, a diagnostic system, a version of a software component, an IP address, a port number, a particular configuration file, an application code location, and a network file system mounting point.

11. A cluster comprising:
plural machines, each configured to read at least one runtime variable that includes a first list of at least one attribute, and at least one configuration variable that includes a second list of at least one attribute;
communication ports configured to connect the plural machines to form the cluster and configured to transit information including the at least one runtime variable and the at least one configuration variable; and
a memory configured to store the at least one runtime variable, the at least one configuration variable, and a platform management service, the platform management service being configured to maintain the at least one configuration variable and to initialize the at least one runtime variable when all the machines of the cluster are shutdown.

12. The cluster of claim 11, wherein at least a machine of the plural machines is configured, after the occurrence of the predetermined event, to:
select the at least one attribute from the first list if the at least one runtime variable is available;
access, if the at least one runtime variable is not available, the at least one configuration variable and select the at least one attribute from the second list; and
use the selected attribute in the machine.

13. A machine that is part of a cluster that includes common control software configured to control the machine and wherein the cluster includes other machines, the machine comprising:
a processor configured to read, upon an occurrence of a predetermined event, at least one runtime variable that includes a first list of at least one attribute, and at least one configuration variable that includes a second list of at least one attribute; and
a memory configured to store the least one runtime variable, the at least one configuration variable, and a platform management service, the platform management service being configured to maintain the at least one configuration variable and to initialize the at least one runtime variable when all the machines of the cluster are shutdown.

14. The machine of claim 13, further configured, upon the occurrence of the predetermined event, to:
select the at least one attribute from the first list if the at least one runtime variable is available;
access, if the at least one runtime variable is not available, the at least one configuration variable and select the at least one attribute from the second list; and
use the selected attribute in the machine.

15. The machine of claim 13, wherein the attribute of the at least one runtime variable and the attribute of the at least one configuration variable are related to one of an operating system, a backup system, a diagnostic system, a version of a software component, an IP address, a port number, a particular configuration file, an application code location, and a network file system mounting point.

16. The machine of claim 14, further comprising:
using the selected attribute to perform at least one of: rebooting the machine, updating a software component of the machine, and transferring data from the cluster to the machine.

17. The machine of claim 13, wherein the predetermined event is a reboot of all the machines of the cluster.

18. The machine of claim 13, wherein the at least one runtime variable is unavailable after the shutdown of all the machines in the cluster.

19. The machine of claim 18, wherein the shutdown of all the machines in the cluster occurs when:
each of the machines loses connectivity to the cluster or does not respond to input commands, or
a user either sends a command to the cluster to reset all the machines or switches off the power of the cluster.

20. The machine of claim 13, wherein the at least one configuration variable is a persistent variable that is available after the shutdown of each machine of the cluster.

21. The machine of claim 13, wherein the attribute of the first list is different from the attribute of the second list.

22. The machine of claim 13, wherein the platform management service is available when operating systems of part of the machines or hardware of the part of the machines fail.

23. A computer readable medium including computer executable instructions, wherein the instructions, when executed by a processor that is part of a machine in a cluster, cause the processor to perform a method comprising:
storing a runtime variable and a configuration variable for each machine of the cluster;
selecting, upon an occurrence of a predetermined event, an attribute from a first list of at least one attribute included in the runtime variable in the cluster;
accessing, if the runtime variable is not available, the configuration variable, wherein the configuration variable includes a second list of at least one attribute of the machine and selecting an attribute from the second list; and
using the selected attribute in the machine.

24. The medium of claim 23, wherein the attribute of the runtime variable and the attribute of the configuration variable are related to one of an operating system, a backup system, a diagnostic system, a version of a software component, an IP address, a port number, a particular configuration file, an application code location, and a network file system mounting point.

25. A machine that is part of a cluster that includes common control software configured to control the machine and other machines of the cluster, the machine comprising:
means for storing a runtime variable and a configuration variable for each machine of the cluster;
means for selecting, upon an occurrence of a predetermined event, an attribute from a first list of at least one attribute included in the runtime variable in the cluster;
means for accessing, if the runtime variable is not available, the configuration variable, wherein the configuration variable includes a second list of at least one attribute and selecting an attribute from the second list; and
means for using the selected attribute in the machine.
